(19) United States
(12) Patent Application Publication
(10) Pub. No.: US 2015/0324073 A1
(43) Pub. Date: Nov. 12, 2015

(54) DISPLAYING ALIGNED EBOOK TEXT IN DIFFERENT LANGUAGES

(71) Applicants: Abraham Phelps Murray, Scituate, MA (US); Shawn Brenneman, Mountain View, CA (US); Oded Fuhrmann, Cupertino, CA (US)

(72) Inventors: Abraham Phelps Murray, Scituate, MA (US); Shawn Brenneman, Mountain View, CA (US); Oded Fuhrmann, Cupertino, CA (US)

(73) Assignee: GOOGLE INC., Mountain View, CA (US)

(21) Appl. No.: 13/528,805

(22) Filed: Jun. 20, 2012

(51) Int. Cl. G06F 3/0483; G06F 17/28; G06F 3/0484; G06F 17/30

(52) U.S. Cl. CPC G06F 3/0483; G06F 17/30598; G06F 17/28; G06F 3/0484; G06F 17/289

(57) ABSTRACT

Aligned passages of text in different languages are displayed on an ebook reader. To provide a reference passage corresponding to a reading passage of an ebook, different-language instances of a same ebook are grouped together. The different-language instances of the ebook are created by human translation and include a reading-language instance and a reference-language instance. Corresponding passages in the different-language instances of the ebook are aligned and information describing a reference passage in the reference-language can be identified and sent in response to a request. The aligned passages of text in different languages may be used, for example, to assist users in comprehending the passage.

### BACKGROUND

1. Technical Field

This disclosure relates generally to displaying aligned passages of text in different languages on an ebook reader.

2. Background

Electronic books (ebooks) are becoming very popular. Ebooks, as with any digital content, can be conveniently purchased online and downloaded to client devices for users to access. A user reading an ebook written in his or her non-native language may come across a passage that the user does not fully understand. For example, a user who is a native Hebrew reader reading an English-language ebook may come across a passage in the English text that uses words new to the user. In this instance, to comprehend the text, the user might wish to refer to the passage in the user's native language. One solution is to perform machine translation of the passage to the user's native language. However, machine-translated text may be inaccurate or, at least, lack nuance present in the original text. This problem is compounded because the user is likely to be requesting translation of an especially complex passage. Thus, machine-translated text is not ideal in this situation.

### SUMMARY

A method, non-transitory computer-readable storage medium, and system for providing a reference passage corresponding to a reading passage of an ebook as described herein. One aspect of the method comprises grouping different-language instances of a same ebook into a group, the different-language instances of the ebook created by human translation of the ebook and including a reading-language instance and a reference-language instance of the ebook. The method further comprises aligning corresponding passages in the different-language instances of the ebook in the group. The method additionally comprises, in response to a request identifying a reading passage in the reading-language instance of the ebook, identifying a reference passage in the reference-language instance of the ebook aligned with the reading passage and sending information describing the identified reference passage in response to the request.

One aspect of the non-transitory computer-readable storage medium stores executable computer program instructions for providing a reference passage corresponding to a reading passage of an ebook. The computer program instructions comprise instructions for grouping different-language instances of a same ebook into a group, the different-language instances of the ebook created by human translation of the ebook and including a reading-language instance and a reference-language instance of the ebook. The computer program instructions further comprise instructions for aligning corresponding passages in the different-language instances of the ebook in the group. The computer program instructions additionally comprise instructions for, in response to a request identifying a reading passage in the reading-language instance of the ebook, identifying a reference passage in the reference-language instance of the ebook aligned with the reading passage and sending information describing the identified reference passage in response to the request.

One aspect of the computer system for providing a reference passage corresponding to a reading passage of an ebook comprises a non-transitory computer readable storage medium storing executable program code. The executable program code comprises code for grouping different-language instances of a same ebook into a group, the different-language instances of the ebook created by human translation of the ebook and including a reading-language instance and a reference-language instance of the ebook. The executable program code further comprises code for aligning corresponding passages in the different-language instances of the ebook in the group. The executable program code additionally comprises code for, in response to a request identifying a reading passage in the reading-language instance of the ebook, identifying a reference passage in the reference-language instance of the ebook aligned with the reading passage and sending information describing the identified reference passage in response to the request.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE FIGURES

FIG. 1 is a high-level block diagram of a communications environment for displaying aligned passages of different-language text on client devices.

FIG. 2A is a diagram illustrating an example of a user interface on the client device having side-by-side display of the reading and reference passages.

FIG. 2B is a diagram illustrating an example of a user interface on the client device having the reference passage displayed in a separate pop-up window from the reading passage.

FIG. 3 is a high-level block diagram of a computer for use as the corpus server or client devices in the communications environment shown in FIG. 1.

FIG. 4 is a block diagram illustrating an exemplary architecture of the alignment engine according to one embodiment.

FIG. 5 is a flowchart illustrating a method of displaying an aligned reference passage to a user of a client device according to one embodiment.

FIG. 6 is a flowchart illustrating a method of providing reference passages in reference languages to client devices according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

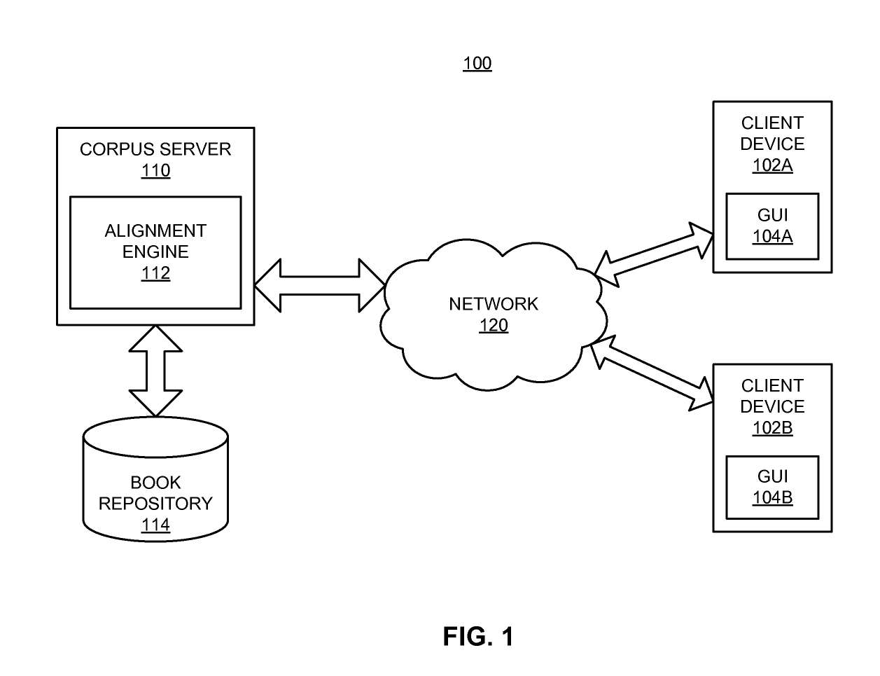

FIG. 1 is a high-level block diagram of a communications environment 100 for displaying aligned passages of different-language text on client devices 102. The environment 100 includes a corpus server 110, a book repository 114, multiple client devices 102 (depicted by way of example in FIG. 1 as client devices 102A and 102B), and a network 120. The network 120 is a data communications network and in one embodiment includes the Internet.

Generally, a user can purchase and download electronic books (ebooks) through a client device 102. When reading an ebook in a first language, the user may instruct the client device 102 to display an identified passage of the ebook in a second language. The client device 102 obtains the corresponding passage of text in the second language from the corpus server 110 and displays it to the user. In one embodiment, the text in the second language is produced by a human translator or via another technique that generates a high-quality translation. Thus, the text in the second language reflects the same tone and nuance of the text in the first language and may assist the user in comprehending the passage, particularly if the user is fluent in the second language but not fluent in the first language.

In one embodiment, the client devices 102 are electronic devices used by users to read ebooks. For example, the electronic devices can be dedicated ebook readers or other general or specific-purpose computing devices such as mobile telephones, or tablet, notebook, or desktop computers executing ebook reading applications. The ebook reading applications can be standalone applications or integrated into operating systems, web browsers or other software executing on the computing devices. While only two client devices 102A, 102B are illustrated in FIG. 1, the environment 100 may include thousands or millions of such devices, as well as multiple corpus servers 110 and/or other entities.

A client device 102 and/or ebook reading application executing on the client device provides a graphic user interface (GUI) 104 (depicted by way of example in FIG. 1 as GUI 104A corresponding to client device 102A and GUI 104B corresponding to client device 102B) that users may use to obtain ebooks via the network 120, read ebooks, and perform various other functions. For example, the GUI may allow the user to specify a reading language for the user as well as one or more reference languages. If the user is multilingual, and desires to read an ebook in a particular language, the user may use the GUI to specify that particular language as the reading language, and specify another language with which the user is conversant as the reference language. For example, if the user is a native Hebrew reader but also able to read in English, the user may use the GUI to set English as the reading language in order to improve the reader's English reading skills. The user may then set Hebrew as the user's reference language.

When reading an ebook in the reading language, the user may use the GUI to select a portion of the text in the reading language. The selected portion of text in the reading language is referred to as the “reading passage” and may include, for example, a page, paragraph, sentence, or sentence fragment. The user may select the reading passage by, e.g., using a cursor, touch-screen gesture, or other technique. In response to selection of the reading passage, the GUI displays an associated “reference passage” with text in the reference language aligned with the reading passage. The reference passage is “aligned” in the sense that it corresponds to the reading passage selected by the user, except that the text of the reference passage is in the reference language.

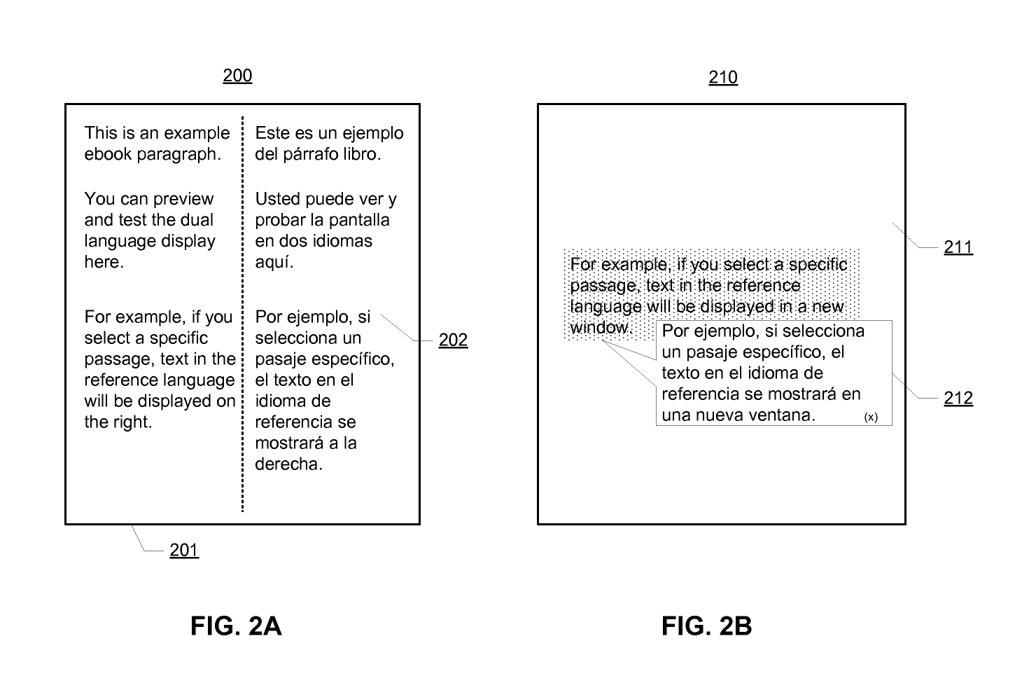

The GUI of the client device 102 may display the reference passage in association with the reading passage in a variety of different ways. For example, the GUI may display the reference passage in a separate window offset from the reading passage, or may display the reference passage in a dual column adjacent to the reading passage. FIG. 2A illustrates an example GUI 200 displayed by the client device 102 having side-by-side display of the reading and reference passages. The GUI 200 presents two columns of text 201, 202. The left column 201 includes the reading passage, which is English-language text in this example. The right column 202 includes the aligned reference passage, which is Spanish-language text in this example. Thus, the user can easily compare the reading passage with the reference passage. Other embodiments may align the columns differently, such as top-and-bottom rather than side-by-side.

FIG. 2B illustrates another example GUI 210 displayed by the client device 102 having the reference passage displayed in a separate pop-up window from the reading passage. The GUI 210 presents a larger window 211 displaying the reading passage. The GUI 210 also presents a smaller window 212 overlaid over the larger window (e.g., popped up over the larger window) displaying an aligned reference passage. In the example GUI 210 of FIG. 2B, the user has selected a particular reading passage, as illustrated by the gray-shading, and the pop-up window 212 displays the reference passage aligned with the selected passage. The pop-up window 212 can be optionally closed by clicking the “x” icon on the bottom right corner. This view option is suitable for users who want to view the reference passage only occasionally. Other embodiments may present the reading and reference passages in different ways.

The corpus server 110 includes one or more computers and provides ebook content including reading and reference passages to the client devices 102. The corpus server 110 may provide the ebook content in a variety of ways. In one embodiment, the corpus server 110 provides ebooks containing both reading and reference passages to the client devices 102 in a single interaction. For example, the corpus server 110 may provide an entire ebook in multiple languages for storage at a client device 102. In another embodiment, the corpus server 110 provides portions of ebooks and/or reference passages to the client devices 102 over multiple transactions. For example, the corpus server 110 may provide a chapter or page of an ebook in response to a request from a client device 102. Then, the corpus server 110 may provide a reference passage to a client device 102 in response to a request that identifies the corresponding reading passage.

The book repository 114 is in communication with the corpus server 110 and includes a database storing ebooks in a variety of languages. Depending upon the embodiment, the book repository 114 may be a relational or other type of database. The database may be local to or remote from the corpus server 110. The ebooks in the repository include text, images, and/or other content that form the ebooks. In addition, each ebook may have associated metadata that describe the ebook, such as describing the ebook's title, author, publication date, publisher, language, International Standard Book Number (ISBN), etc. The metadata may also describe the structure of content within the ebook, such as the pagination, chapter divisions, etc.

In one embodiment, the book repository 114 stores different-language instances of ebook titles. For example, the book repository 114 may store ebook instances of “Ulysses” by James Joyce in its original English language, and in foreign languages such as Spanish, French, and Hebrew. Further, in one embodiment, the texts of the foreign-language versions of the ebooks are composed manually by human translators of the original texts. Many ebooks are published in a variety of languages, and the foreign—(i.e., non-native) language versions of the ebooks are translated by human translation specialists.

The human-translated versions of the ebooks include the same tone, nuance, and other esthetic characteristics found in the native-language versions of the books. In order to capture these esthetic characteristics, the translator may deviate from literal translation when translating the books. Human translation is in contrast to machine translation in which it is more likely that the translated text is a literal translation of the original text.

The corpus server 110 includes an alignment engine 112 that aligns corresponding passages in different-language instances of ebooks. For a given ebook, such as “Ulysses”, the alignment engine 112 identifies the instances of the ebook in multiple different languages stored in the book repository 114 and aligns the corresponding passages in the different-language versions. When a request for a reference passage corresponding to specified reading passage in an ebook is received from a client device 102, the alignment engine 112 identifies the reference passage corresponding to the text passage to the corpus server 110.

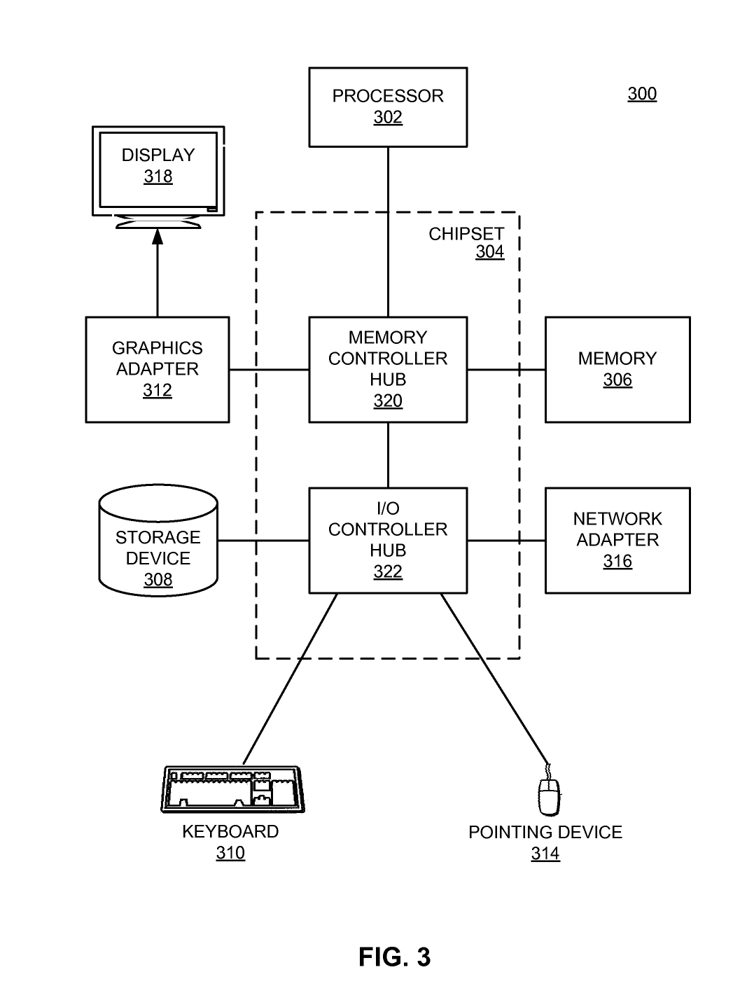

FIG. 3 is a high-level block diagram of a computer 300 for use as the client devices 102 or corpus server 110 in the communications environment 100 shown in FIG. 1. In addition, the computer 300 may be used to implement the book repository 114. Illustrated are at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display device 318 is coupled to the graphics adapter 312. A storage device 308, keyboard 310, pointing device 314, and network adapter 316 are coupled to the I/O controller hub 322. Other embodiments of the computer 300 have different architectures. For example, the memory 306 is directly coupled to the processor 302 in some embodiments.

The storage device 308 is a non-transitory computer-readable storage medium such as a hard drive, compact disk read-only memory (CD-ROM), DVD, or a solid-state memory device. The memory 306 holds instructions and data used by the processor 302. The pointing device 314 is a mouse, track ball, or other type of pointing device, and is used in combination with the keyboard 310 to input data into the computer 300. The graphics adapter 312 displays images and other information on the display device 318. The network adapter 316 couples the computer 300 to a network. Some embodiments of the computer 300 have different and/or other components than those shown in FIG. 3. The types of computer 300 can vary depending upon the embodiment and the desired processing power. The computer 300 may comprise multiple blade servers working together to provide the functionality described herein.

The computer 300 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 308, loaded into the memory 306, and executed by the processor 302.

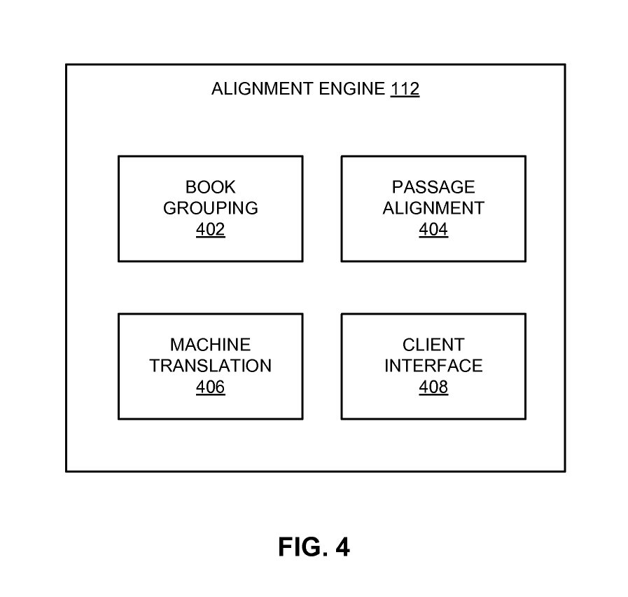

FIG. 4 is a block diagram illustrating an exemplary architecture of the alignment engine 112 according to one embodiment. The alignment engine 112 includes a book grouping module 402, a passage alignment module 404, a machine translation module 406, and a client interface 408. Other embodiments may include different or additional modules.

The book grouping module 402 groups together different-language instances of the same ebook contained in the book repository 114. Thus, for example, the book grouping module 402 may identify and group together (e.g., cluster) the English, French, and Hebrew instances of the novel “Ulysses” by James Joyce. The book grouping module 402 may group the ebooks using a variety of different techniques.

In one embodiment, the book grouping module 402 groups the ebooks using metadata associated with the ebooks. The book grouping module 402 examines the metadata associated with the various ebooks in the repository 114 to identify the different-language instances of the same ebooks. For example, different translations of a given ebook may share the same metadata, such as book title, author, publisher, series title, and publishing date.

In another embodiment, the book grouping module 402 performs a textual analysis of the ebooks in the repository 114 to identify different-language instances of the same ebooks. For this embodiment, the book grouping module 402 identifies a basis language, e.g., English. The book grouping module 402 then uses machine translation to translate ebooks in the repository 114 that are not already in the basis language to that language. The book grouping module 402 next analyzes the ebook texts in the basis language to cluster the ebooks based on textual similarity. For example, the book grouping module 402 may cluster together ebooks having a threshold measure of textual similarity. Instances of the same ebook that are in different languages will tend to have similar texts when machine translated to the same basis language. Therefore, clustering based on textual similarity forms clusters of instances of the same ebook. The book grouping module 402 accordingly identifies the ebooks within a given cluster as being different-language instances of the same ebook.

The passage alignment module 404 aligns passages of text in different-language instances of an ebook. “Alignment” refers to identifying a passage of text in one language of an ebook that generally corresponds to an equivalent passage of text in another language of the ebook. That is, the text in the first language of the ebook has the same or a similar meaning as the text in the second language, subject to variations introduced due to translation.

In one embodiment, the passage alignment module 404 performs the alignment by using machine translation to translate different-language instances of an ebook into a same basis language. The same machine translations generated by the book grouping module 402 may be used by the passage alignment module 404. During this translation, the passage alignment module 404 maintains data describing the mapping between the text in the original language (i.e., the non-basis language version) of the ebook and the translated basis-language text. Thus, for each passage of the basis language text, the passage alignment module 404 can identify the location of the passage in the original language text from which the basis language text was generated.

The passage alignment module 404 compares the basis language versions of the ebook instances in order to identify highly-similar passages. The passage alignment module 404 may compare each basis language passage with the version of the passage originally in the basis language in order to identify highly-similar passages. For example, if the basis language is English, the passage alignment module 404 may separately compare the basis language passages translated from the French, Spanish, and Hebrew versions of “Ulysses” with the original English language version of “Ulysses” in order to identify passages in the foreign-language texts that are highly-similar to the English-language passages. Alternatively, the passage alignment module 404 may compare each basis language passage with each other basis language passage to identify highly-similar passages.

In one embodiment, “highly-similar” is determined by comparing passages (e.g., sentences, paragraphs) using a similarity metric that produces a score indicating the amount of similarity between the passages. The score may be based, for example, on the number of words or characters in common, the orders in which the words and/or characters appear, and weights assigned to certain words and/or characters. The passages having a score above a threshold are considered “highly-similar.” The passage alignment module 404 records these highly-similar passages as being aligned.

In one embodiment, the passage alignment module 404 uses the metadata describing the ebook structures when identifying highly-similar passages. The passage alignment module 404 uses the metadata to reduce the amount of basis-language text to compare when identifying highly-similar passages. For example, the passage alignment module 404 may use metadata describing chapters in order to compare basis language passages within the same chapter of an ebook. Generally, chapter divisions are expected to remain the same across instances of ebooks in different languages. Therefore, by comparing basis language passages from the same chapter of different ebook instances, the passage alignment module 404 increases the likelihood that highly-similar passages do, in fact, correspond to the same passages in the ebook instances.

The passage alignment module 404 stores alignment data describing the locations of the aligned passages. The alignment data indicate the locations of passages in a given instance of an ebook that, when translated to the basis language, align with basis-language passages in specified locations of other-language instances of the same ebook. For example, the alignment data may specify the locations of passages in the Hebrew-language instance of “Ulysses” that, when translated to English (the basis language), align with specified passages of the English-language instance of “Ulysses”. The alignment data may also specify locations of passages in other language instances of “Ulysses” that align with specific passages of the English-language instance. Thus, the alignment data may be used to align passages in any language instance with passages in any other language instance of the ebook.

The machine translation module 406 provides machine translation of text, such as ebook passages, on behalf of other modules in the alignment engine 112. In one embodiment, the machine translation module 406 receives an input of text in one language, performs substitution of words, and applies grammar rules to produce an output of the same text in another language. The machine translation module 406 may interact with an external machine translation resource to perform the translations, such as the GOOGLE TRANSLATE service provided by GOOGLE INC. The machine translation module 406 may be used, for example, to translate text into the basis language on behalf of the book grouping module 402 and the passage alignment module 404.

The client interface module 408 interacts with the client devices 102 to provide aligned passages. In one embodiment, the client interface module 408 receives a request for an aligned passage from a client device 102. The request includes passage identification information identifying a reading passage for which an aligned reference passage is requested. To this end, the request may identify one or more of the ebook, the reading language, the reference language, and the location of the reading passage within the ebook. The request may also include related information such as an identifier of the user of the client device, an identifier of the client device, and/or any other information that is necessary or desired.

In response to receiving a request, the client interface module 408 uses the passage identification information, in combination with the alignment data stored by the passage alignment module 404, to identify the aligned reference passage. The client interface module 408 responds to the request by sending the client device 102 reference passage information describing the aligned reference passage. In one embodiment, the client interface module 408 retrieves the text of the reference passage from the reference-language ebook instance in the book repository 114 and provides that text as the reference passage information. In another embodiment, the client interface module 408 provides the location in the reference-language ebook instance at which the aligned reference passage is located to the client device 102 and the client device uses this information to obtain the reference passage.

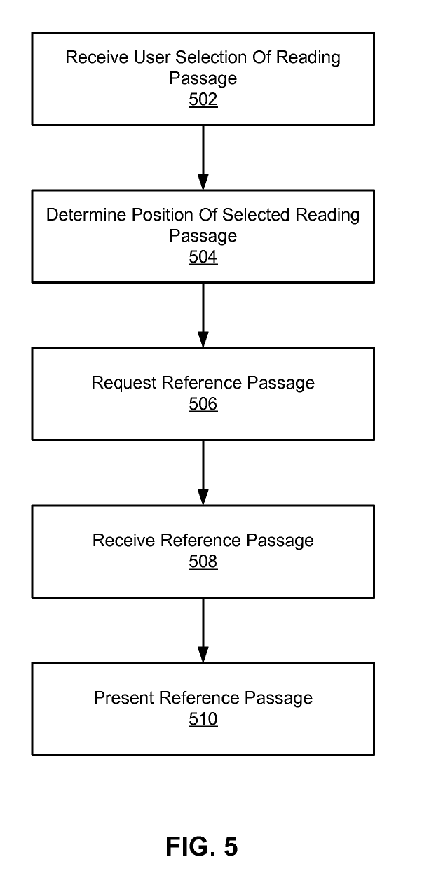

FIG. 5 is a flowchart illustrating a method of displaying an aligned reference passage to a user of a client device 102 according to one embodiment. In the described embodiment, the steps of the method are performed by a client device 102. However, some or all of the steps may be performed by other entities in other embodiments. Likewise, other embodiments may include different and/or additional steps that the ones described herein.

In step 502, the client device 102 receives a selection of a reading passage in a reading language for which the user requests an aligned reference passage in a reference language. The reading passage is contained within an ebook. The client device 102 may receive the selection in response to a gesture or other input by the user. The client device 102 then determines (step 504) the position of the selected reading passage in the ebook. The client device 102 then identifies the corresponding reference passage by, e.g., sending (step 506) a request for the reference passage to the corpus server 110. The request includes passage identification information identifying the position of the selected reading passage. In response, in step 508, the client device 102 receives from the corpus server 110 reference passage information describing the aligned reference passage. The client device 102 then obtains, if necessary, and presents (step 510) the reference passage to the user. For example, the client device 102 may display the reference passage in a pop-up window or in a dual column view. The reference passage contains a human-generated translation of the text in the reading passage and may, therefore, assist the user in comprehending the reading passage.

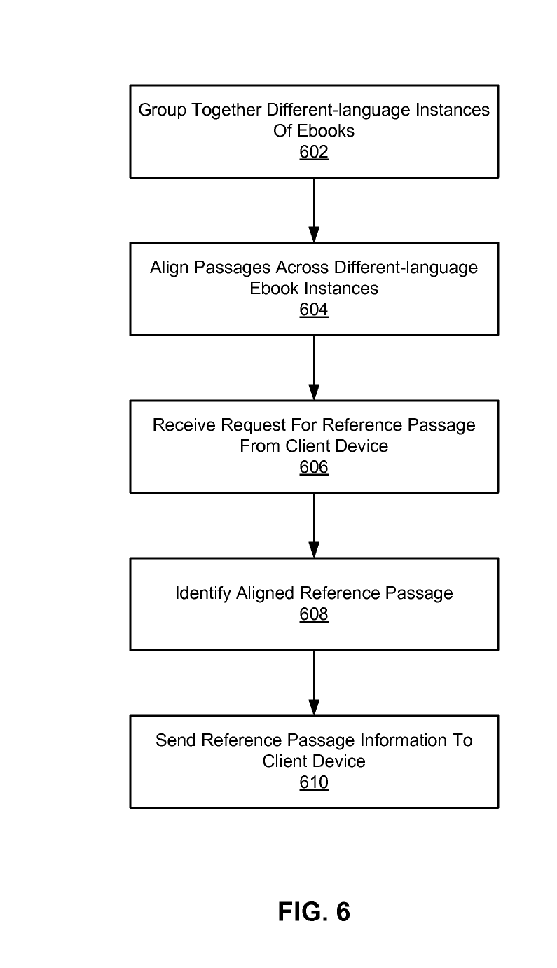

FIG. 6 is a flowchart illustrating a method of providing reference passages in reference languages to client devices 102 according to one embodiment. The steps of the method are performed by the alignment engine 112 of the corpus server 110 in one embodiment but may be performed by other entities. Likewise, other embodiments may perform different and/or additional steps.

In step 602, the alignment engine 112 groups together different-language instances of ebooks into clusters, so that a single cluster contains different-language instances of the same ebook. This clustering may be performed by using machine translation to translate ebooks in the repository 114 into a basis language, and clustering the basis-language ebooks based on textual similarity. For a cluster containing different-language ebook instances, in step 604, the alignment engine 112 aligns corresponding passages across the ebook instances. As described above, the alignment can be achieved by machine-translating the text of the ebook instances in the cluster into a common basis language, and comparing the basis language versions of the texts to identify highly-similar passages. The alignment engine 112 stores alignment data indicating locations of aligned passages in the different-language ebook instances.

In step 606, the alignment engine receives a request for a reference passage in a reference language from a client device 102. The request includes passage identification information identifying the location of a reading passage in an instance of an ebook in a reading language. In response to the request, in step 608, the alignment engine 112 uses the passage identification information to identify an aligned passage in the reference language that corresponds to the reading passage. In step 610, the alignment engine 112 sends reference passage information describing the aligned reference passage to the client device 102. The reference passage information can include the text of the reference passage, and/or information the client device 102 can use to obtain the reference passage.

The foregoing description of embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A method of providing a reference passage corresponding to a reading passage of an ebook, comprising:
grouping, by a computer, different-language instances of a same ebook into a group, the different-language instances of the ebook created by human translation of the ebook and including a reading-language instance and a reference-language instance of the ebook;
aligning, by the computer, corresponding passages in the different-language instances of the ebook in the group, the aligning comprising:
translating, using machine translation, texts of the different-language instances of the ebook into a same basis language to create basis-language texts of the ebook instances;
comparing the basis-language texts of the ebook instances to identify similar passages in the ebook instances; and
storing alignment data describing the locations in the ebook instances of the similar passages;
identifying, by the computer and in response to a request for identification of a reading passage in the reading-language instance of the ebook, a reference passage in the reference-language instance of the ebook aligned with the reading passage; and
sending, by the computer, information describing the identified reference passage in response to the request.

2. The method of claim 1, wherein grouping different-language instances of the ebook into a group comprises:
translating, using machine translation, texts of different-language instances of multiple different ebooks into basis-language texts of the ebooks;
analyzing the basis-language texts of the instances of the multiple different ebooks to identify similar basis-language texts; and
clustering the different-language instances of the multiple different ebooks responsive to the analysis to produce clusters of different-language instances of same ebooks.

3. The method of claim 2, wherein the clustering clusters different-language instances of ebooks having similar basis-language texts together in a same cluster.

4. (canceled)

5. The method of claim 1, wherein comparing the basis-language texts of the ebook instances comprises:
identifying metadata describing a structure of the ebook; and
using the identified metadata to reduce an amount of basis-language text to compare when identifying similar passages in the ebook instances.

6. The method of claim 1, further comprising:
receiving the request for identification of the reading passage from a client device displaying the reading-language instance of the ebook, the client device receiving a selection of the reading passage from a user of the client device;
wherein sending information comprises sending text of the identified reference passage to the client device in response to the request identifying the reading passage, and the client device displays to the user the reference passage in association with the reading passage.

7. The method of claim 1, wherein identifying a reference passage in the reference-language instance of the ebook aligned with the reading passage comprises:
receiving passage identification information identifying a location of the reading passage within the reading-language instance of the ebook;
determining, based on the location of the reading passage, an aligned corresponding passage in the reference-language instance of the ebook; and
identifying the aligned corresponding passage as the reference passage aligned with the reading passage.

8. A non-transitory computer-readable storage medium storing executable computer program instructions for providing a reference passage corresponding to a reading passage of an ebook, the computer program instructions comprising instructions for:
grouping different-language instances of a same ebook into a group, the different-language instances of the ebook created by human translation of the ebook and including a reading-language instance and a reference-language instance of the ebook;
aligning corresponding passages in the different-language instances of the ebook in the group, the aligning comprising:
translating, using machine translation, texts of the different-language instances of the ebook into a same basis language to create basis-language texts of the ebook instances;
comparing the basis-language texts of the ebook instances to identify similar passages in the ebook instances; and
storing alignment data describing the locations in the ebook instances of the similar passages;
identifying, in response to a request for identification of a reading passage in the reading-language instance of the ebook, a reference passage in the reference-language instance of the ebook aligned with the reading passage; and
sending information describing the identified reference passage in response to the request.

9. The storage medium of claim 8, wherein grouping different-language instances of the ebook into a group comprises:
translating, using machine translation, texts of different-language instances of multiple different ebooks into basis-language texts of the ebooks;
analyzing the basis-language texts of the instances of the multiple different ebooks to identify similar basis-language texts; and
clustering the different-language instances of the multiple different ebooks responsive to the analysis to produce clusters of different-language instances of same ebooks.

10. The storage medium of claim 9, wherein the clustering clusters different-language instances of ebooks having similar basis-language texts together in a same cluster.

11. (canceled)

12. The storage medium of claim 8, wherein comparing the basis-language texts of the ebook instances comprises:
identifying metadata describing a structure of the ebook; and
using the identified metadata to reduce an amount of basis-language text to compare when identifying similar passages in the ebook instances.

13. The storage medium of claim 8, wherein the computer program instructions further comprise instructions for:
receiving the request for identification of the reading passage from a client device displaying the reading-language instance of the ebook, the client device receiving a selection of the reading passage from a user of the client device;
wherein sending information comprises sending text of the identified reference passage to the client device in response to the request identifying the reading passage, and the client device displays to the user the reference passage in association with the reading passage.

14. The storage medium of claim 8, wherein identifying a reference passage in the reference-language instance of the ebook aligned with the reading passage comprises:
receiving passage identification information identifying a location of the reading passage within the reading-language instance of the ebook;
determining, based on the location of the reading passage, an aligned corresponding passage in the reference-language instance of the ebook; and
identifying the aligned corresponding passage as the reference passage aligned with the reading passage.

15. A computer system for providing a reference passage corresponding to a reading passage of an ebook, comprising:
a non-transitory computer readable storage medium storing executable program code comprising code for:
grouping different-language instances of a same ebook into a group, the different-language instances of the ebook created by human translation of the ebook and including a reading-language instance and a reference-language instance of the ebook;
aligning corresponding passages in the different-language instances of the ebook in the group, the aligning comprising:
translating, using machine translation, texts of the different-language instances of the ebook into a same basis language to create basis-language texts of the ebook instances;
comparing the basis-language texts of the ebook instances to identify similar passages in the ebook instances; and
storing alignment data describing the locations in the ebook instances of the similar passages;
identifying, in response to a request for identification of a reading passage in the reading-language instance of the ebook, a reference passage in the reference-language instance of the ebook aligned with the reading passage; and
sending information describing the identified reference passage in response to the request; and
a processor for executing the program code.

16. The system of claim 15, wherein grouping different-language instances of the ebook into a group comprises:
translating, using machine translation, texts of different-language instances of multiple different ebooks into basis-language texts of the ebooks;
analyzing the basis-language texts of the instances of the multiple different ebooks to identify similar basis-language texts; and
clustering the different-language instances of the multiple different ebooks responsive to the analysis to produce clusters of different-language instances of same ebooks.

17. (canceled)

18. The system of claim 15, wherein comparing the basis-language texts of the ebook instances comprises:
identifying metadata describing a structure of the ebook; and
using the identified metadata to reduce an amount of basis-language text to compare when identifying similar passages in the ebook instances.

19. The system of claim 15, wherein the executable program code further comprises code for:
receiving the request for identification of the reading passage from a client device displaying the reading-language instance of the ebook, the client device receiving a selection of the reading passage from a user of the client device;
wherein sending information comprises sending text of the identified reference passage to the client device in response to the request identifying the reading passage, and the client device displays to the user the reference passage in association with the reading passage.

20. The system of claim 15, wherein identifying a reference passage in the reference-language instance of the ebook aligned with the reading passage comprises:
receiving passage identification information identifying a location of the reading passage within the reading-language instance of the ebook;
determining, based on the location of the reading passage, an aligned corresponding passage in the reference-language instance of the ebook; and
identifying the aligned corresponding passage as the reference passage aligned with the reading passage.
